(19) United States
(12) Patent Application Publication
(10) Pub. No.: US 2004/0029066 A1
(43) Pub. Date: Feb. 12, 2004

(54) Orthodontic appliance and pin

(76) Inventor: Felix Goldschmied, Launceston (AU)

Correspondence Address: LADAS & PARRY, 26 WEST 61ST STREET, NEW YORK, NY, 10023, US

(21) Appl. No.: 10/415,864

(22) PCT Filed: Nov. 5, 2001
(86) PCT No.: PCT/AU01/01427

(30) Foreign Application Priority Data
Nov. 6, 2000 (AU) PR1280

(51) Int. Cl. A61C 3/00

(52) U.S. Cl. 433/14; 433/9

(57) ABSTRACT

An orthodontic appliance including a bracket having a substantially flat base (15) for engaging a tooth and a securing member (23) having a terminal aspect, and a pin (1) having an appendage (5) having an active surface (3) wherein the base and the securing member form a channel adapted to receive the pin to secure the pin in a position to form a slot between the terminal aspect of the securing member and the active surface of the appendage of the pin, said pin having longitudinal movement within the channel, wherein said movement enable the dimensions of the slot formed between the terminal aspect of the securing member and the active surface (32) of the appendage of the pin to be variable.

This invention relates generally to the field of orthodontics and in particular to a novel orthodontic appliance able to accommodate a series of slidable pins. The invention also relates to an improved base for such an appliance and to specific pins with a locking mechanism. In addition, the invention relates to a technique of utilising the pins and the appliance.

The field of orthodontics typically involves appliances and methods relating to the application of these appliances to teeth of a patient in order to straighten or in some manner move the teeth within the mouth to a more desirable position. Treatment with such appliances are generally for cosmetic or other function purposes.

Whilst a number of methods have been used, the most commonly used method involves the use of brackets which are affixed to the tooth surface, and archwires which are held in position by the brackets to apply a force to the tooth. Correct manipulation of the archwire and the bracket, allows the operator to apply forces upon a tooth in an attempt to cause movement. Various modifications of this basic method have developed utilising differing brackets and archwires in order to provide orthodontic treatment. One example of such a method is the Begg technique which involves the gentle free tipping movement of the teeth. The teeth may be moved into existing spaces or spaces created by extracting strategic teeth. Other techniques utilise Edgewise brackets and variations of the Edgewise bracket in order to induce movement of teeth.

A bracket is a device that is generally attached either directly to the tooth by the use of a dental binding agent or by means of a band surrounding the tooth which holds the bracket in position. Brackets of this type may include a horizontal projection to support an archwire. Generally, the appliances used in current methods utilise brackets and an archwire. The archwire is generally secured to the bracket by means of ligatures, or by the use of pins or other holding devices. The archwire may be secured within the bracket or received between the bracket surface and the insure of the bracket and held firmly against the inside of the bracket.

Appliances that are used in orthodontic treatments are classified generally according to their surface application. Such appliances include labial and buccal, utilising appliances that are applied to the outer surface of the tooth, lingual and palately utilising appliances affixed to the interior surface of the tooth, or labialingual applied to both surfaces. Generally, the Edgewise technique is a labial and buccal arch technique that allows for suitable control in the labiolingual, mesiodistal and gingival directions. In the Edgewise appliance, a round or rectangular archwire is layed flat against the labial/buccal surface of the tooth. The archwire is shaped and affixed into a support in the brackets.

The orthodontic appliance of the present invention represents an improvement in, or modification of the orthodontic appliance described in Australian Application 72071/96 (728173), the entire disclosure of which is incorporated herein and by reference.

The appliance described in Australian Application 72071/96 (728173), comprises a bracket having a base and a securing member, which forms a channel able to accommodate a pin. The pin retains longitudinal movement within the channel formed between the base and the securing member. The longitudinal movement of the pin, which maybe described as a slide due to this movement, is able to vary the dimensions of a slot formed between an appendage (or foot) of the pin and the V-shaped terminal aspect of the securing member of the base. The slot formed within the orthodontic appliance is able to accommodate an archwire.

The longitudinal movement of the pin varies the dimensions of the slot. The slot itself is actually formed between an active surface of the appendage of the pin and the terminal aspect of the securing member which may be V-shaped.

The movement of the pin within the channel provides the orthodontic appliance with the ability to transform functional vertical forces applied by the pin to horizontal force components in the direction designated by the orthodontist and determined by the configuration of the functional components of the pin.

This results in a more natural movement of tooth through bone, utilising minimal force stimuli on periodontal membranes. Furthermore, the forces (stimuli) so expressed are intermittent light force stimuli which allows better tooth movement when compared to heavier forces typically applied by more conventional systems. This is all due to the two part bracket which allows for slide movement of the pin which allows for changes in the slot dimension. The torque and angulation can be directed exactly and infinitely by the orthodontist during treatment without the need to debond the bracket from the tooth. The pin maybe removed and replaced to provide alternative treatment.

The slide movement of the pin varies the dimension of the slot which permits variable forces to be applied to the tooth. It also permits lighter forces at the time of application to be disseminated or cushioned by the opening of the slot. The force (energy) so absorbed is then reapplied with less force employed over a period of time as the slot commences to close again thereby, shielding the periodontal membranes from application of excessive force and from undue periodontal, bone and tooth damage.

The sliding movement of the pin moves the application of a component of the force from a vertical component to a horizontal component. The forces cause the tooth to initially tip in the direction of the designated tooth movement as the slot opens, as determined by the orthodontists placement of the prescribed pin with predetermined angulation and torque. The tooth is then uprighted to the prescribed angulation of the slot. The tooth is effectively “stepped” along the archwire. The prescription, and the direction of tooth movement can be changed at any time during treatment by simply changing the pin. Torque and angulation can be altered infinitely by changing the pin and slot dimensions without debonding the base from the tooth.

Longitudinal movement of the pin varies the dimension of the slot resulting in different forces being applied to the tooth. Continuous longitudinal movement, a consequence of functional forces that continually alter the slot size can translate the vertical component of force into horizontal components, through the angulation created by placement of the pin in the channel formed in the bracket.

This translation of force and the ability of the bracket slot to open and close, lessens the demand for anchorage mechanics. The tooth moves more easily and rapidly because of this opening and closing movement which results in less friction.

The discussion of the appliance described in Australian Application 72071/96 is background to the invention described herein and is included to explain the context of the invention. This is not to be taken as an admission that any of the material referred to is or was known or part of the common general knowledge in Australia.

### SUMMARY OF THE INVENTION

In one aspect, the present invention provides an orthodontic appliance including:

a bracket having:

a substantially flat base for engaging a tooth, and

a securing member having a terminal aspect; and

a pin having an appendage having an active surface;

wherein the base and the securing member form a channel, adapted to receive the pin to secure the pin in a position to form a slot between the terminal aspect of the securing member and the active surface of the appendage of the pin;

said pin having longitudinal movement within the channel, wherein said movement enables the dimensions of the slot formed between the terminal aspect of the securing member and the active surface of the appendage of the pin to be variable.

In a preferred aspect of the invention, the terminal aspect of the securing member and the active surface of the appendage of the pin are complementary so as to maximise the transfer of force caused by interaction of the bracket and the archwire to the tooth.

The complimentary surface of the terminal aspect of the securing member and the active surface of the appendage of the pin enabled the operator to provide a preset angulation and/or torque movement for the tooth. That is, the angle is set to define a particular movement which the operator would be looking for.

In a further embodiment there is provided an orthodontic applicance including:

a bracket, having:

a substantially flat base for engaging a tooth and,

a securing member having a V-shaped terminal aspect;

and a pin having a stem and a foot type appendage, toward one end of the stem,

said pin having an active surface on the upper surface of the foot type appendage;

when the base and the securing member form a channel adapted to receive the pin to secure the pin in a position to form a slot between the terminal aspect and the active surface of the appendage of the pin;

said pin having longitudinal movement within the channel, wherein said movement enables the dimensions of the slot formed between the V-shaped terminal aspect and the active surface of the appendage of the pin to be variable.

In a further aspect, the present invention provides an orthodontic appliance including:

a bracket, having:

a substantially flat base for engaging a tooth and,

a securing member having a terminal aspect; and

a pin having an appendage having an active surface;

wherein the base and the securing member form a channel adapted to receive the pin to secure the pin in a position to form a slot between the terminal aspect of the securing member and the active surface of the appendage of the pin;

said pin having longitudinal movement within the channel, wherein said movement enables the dimensions of the slot formed between the terminal aspect of the securing member and the active surface of the appendage of the pin to be variable,

wherein said pin further includes a locking means.

An advantage provided by the locking means is that it will enable the operator to hook an auxiliary directly to the pin.

### DESCRIPTION OF THE FIGURES

FIG. 1(a) is illustrative of a front view of a pin that may be used in the orthodontic appliance of the invention.

FIG. 1(b) is illustrative of a side view of a pin that may be used in the orthodontic appliance of the invention.

FIG. 2 illustrates the adhesive surface of the base of the bracket of a preferred embodiment of the invention.

FIG. 3 illustrates a side view of the appliance having an adhesive surface.

FIG. 4(a), 4(b) and 4(c) illustrate a top, front and side views respectively of a preferred bracket of the invention.

FIGS. 4(d), 4(e) and 4(f) illustrate a top, side and front views respectively of a preferred pin of the invention.

FIGS. 5(a), 5(b) and 5(c) illustrate a top, front and side views respectively of a preferred bracket of the invention.

FIGS. 5(d), 5(e) and 5(f) illustrate a top, side and front view respectively of a further preferred pin of the invention.

FIGS. 6(a), 6(b) and 6(c) illustrate a top, front and side view of a further preferred bracket of the invention.

FIGS. 6(d), 6(e) and 6(f) illustrate top, side and front perspective of a preferred pin of the invention.

### DETAILED DESCRIPTION OF THE INVENTION

The present invention provides an orthodontic appliance including:

a bracket having:

a substantially flat base for engaging a tooth, and

a securing member having a terminal aspect; and

a pin having an appendage having an active surface;

wherein the base and the securing member form a channel, adapted to receive the pin to secure the pin in a position to form a slot between the terminal aspect of the securing member and the active surface of the appendage of the pin;

said pin having longitudinal movement within the channel, wherein said movement enables the dimensions of the slot formed between the terminal aspect of the securing member and the terminal surface of the appendage of the pin to be variable.

The pin has an appendage which defines the shape of the slot formed between the active surface of the appendage of the pin and the terminal aspect of the securing member. The shape of the slot is such that it can accommodate round, rectangular or ribbon archwires or other auxiliary binding if required.

The wire dimensions can be infinitely varied within orthodontic wire dimension range, with the slot formed within the bracket able to accommodate one or more wires and self adjust accordingly.

The pins can readily be changed in order to adjust the dimension and geometry of the slot formed between the active surface of the pin and the terminal aspect of the securing member within the orthodontic appliance. The pin can be varied to change the angulation and/or torque provided by the slot without debonding the base from the tooth.

The pin is able to move within the channel of the orthodontic appliance so as to adapt to forces being applied to the tooth by the archwires and by the auxiliaries to allow tipping and uprighting of the tooth in response to the opening and closing movement of the pin.

The pin forms part of the orthodontic appliance and is an active component of the appliance in that it provides the mechanics of the slot. The pin generally consists of a stem with appendage being located at one end of the stem. The appendage includes an active surface and preferably also includes a recess opposite to such active surface, said recess having at least one contact surface. The pin is adapted to be secured within the channel formed between the base of the bracket and the securing member, in such a manner so as to prevent rotation of the pin, but allow for longitudinal movement of the pin. In one form, the appendage may be considered to be foot like, having an upper and lower surface and positioned toward one end of the stem. The active surface is on the upper surface of the foot like appendage.

During treatment, the pin may be replaced, and a number of different pins may be used each having different active surface or surfaces, to apply a different treatment to the tooth. The active surface or surfaces of the pin, in conjunction with an archwire, is able to apply a prescribed force upon a tooth of a patient. Generally, the applied force is torque or angulation force.

A different type of pin may be used on a different tooth at any one time. A specific pin may be manufactured and utilised for the appliance depending upon treatment. In such a case, it is the active surface of the pin that is customised to give the desired treatment. It is typical that the features of the appendage and the pins are varied. The stem is generally the same between pins. During the treatment of a patient, a plurality of different pins may be used with a particular appliance through the course of treatment.

The pins may be made from any suitable material, but are preferably made from titanium or stainless steel or other metal depending upon the type of movement which is required.

The pins may be formed to provide initial pins and also finishing, rotational, angulation and torquing pins. The pins should be made such that each pin is able to locate securely within the channel formed between the bracket and the securing member. Because the pins are able to fit into the channel and are held within the bracket, the pin cannot rotate and therefore modification of the appendage of the pin can be utilised for desirable tooth movements.

As stated previously, the pin preferably contains a locking means to limit or control the longitudinal movement of the pin within the appliance. In a particularly preferred embodiment, the locking means is an adjustable locking means wherein the locking mechanism can be adjusted to vary the movement of the pin.

The locking means may be of any form able to limit the movement of the pin within the channel, but is preferably in the form of a butterfly clip at the head of the stem, which when twisted is able to lock the pin in the channel formed within the securing member to limit the movement of the pin. This enables the operator to either limit the opening and closing action of the slot formed within the orthodontic appliance, and to prevent the pin from falling out.

A further advantage of the slight movement of the pin prevents binding within the slot of the appliance between the appliance and the archwire. The movement of the pin enables any form of binding to be broken during treatment.

The active surface of the appendage may be varied in shape to create a different shape for the slot, depending upon the movement required for each individual tooth. For example, the active surface may be flat or sharp edged and/or angled labialy, buccaly, lingualy or palately depending upon the prescribed treatment or archwire used. The pin and bracket arrangement effectively allows positive and negative root torque and other movements to take place on alternate teeth in a specifically designated way and at any time during treatment. The pins may be individualised in a patient to provide a prescribed treatment for each tooth.

Aspects of the appliance if made from titanium or other suitable alloys can be anodised to provide a range of various colour options. The terminal aspect of the securing member may be varied in shape to create a different shape for that side of the slot. For example, the terminal aspect may be flat or sharp angled and may angle labially, buccaly, lingualy or palately, depending on the prescribed treatment.

It is preferred that the terminal aspect of the securing member and the active surface of the appendage of the pin are complementary and cooperate with each other to provide a prescribed force to the tooth. By complementary, it is meant that the interaction of these surfaces with the archwire in the slot leads to both pin and bracket transferring a force to the tooth. Thus, for example, if no force is to be applied to a particular tooth, it is preferred that both the terminal aspect of the securing member and the active surface of the recess of the pin are substantially parallel to each other and to the direction of the archwire when in use. As such, they are substantially perpendicular to the longitudinal axis of the stem of the pin and therefore there is little interaction between these surfaces and the archwire. In these circumstances, there is little force transferred from the archwire to the tooth.

If a torsional force (torque) and/or angulation is required to be applied to the tooth, generally both the terminal aspect of the securing member and the active surface of the appendage of the pin are both inclined at an angle relative to the plane defined by the base of the bracket to provide a prescribed movement to the tooth. The angle can vary depending on the amount of torsional force and/or angulation to be applied to the tooth and the amount of correction ultimately required. The amount of angle in the terminal aspect of the securing member, and the active surface of the appendage of the pin determines a preset angulation and/or torque movement for the tooth.

A pin is generally adapted to provide either torque or angulation as required. In instances where both torsion and angulation are required, the terminal aspect of the securing member and the active surface of the pin can be modified in both ways described in the preceding paragraphs to produce the combined effect.

The base of the bracket may be considered to be substantially flat. However, in one preferred embodiment of the invention, the bracket may have an adhesive surface comprising a plurality of raised surfaces on the surface of the base that adheres to the tooth. The raised surfaces increase the surface area of contact of the base which leads to improved bonding to the tooth. In one form the raised surfaces comprise a raised edge around the total base perimeter of the bracket with a number of elevated fingers filling the surface of the base.

Preferably, the elevated fingers are rectangular posts having a size of approximately 0.25 to 0.35 mm×0.1 to 0.2 mm in dimension and a height of from 0.15 to 0.25 mm. The rectangular posts or fingers can be arranged in any desired formation and generally there will be from about 40 to 50 posts on the base surface. Whereas the base is substantially flat, some variation in the shape may occur to account for the shape of the surface of the tooth. That is, the base may have some curvature or may be angulated to provide some torque for the tooth.

The appliance may also be ligated, wherein a C-clamp or alternatively a spring or elastic may be used to assist in maintaining the pin in the bracket channel.

The C-clamp or auxiliaries may be used with all techniques and at any time after the archwires are seated firmly in the bracket. They may be used during a tip control procedure and whilst uprighting with no uprighting springs or auxiliaries required. The auxiliaries may be affixed around the locking means of the pin to assist in driving the pin toward the terminal aspect of the securing member.

In use, the stem of the pin preferably faces gingivally with the appendage facing occlusally, and the terminal aspect of the securing member facing occlusally although to orientation of the appliance is not limited to this orientation. Preferably, the pin includes a recess having a contact surface on the occlusal surface of the appendage. An elastic, spring or alternative auxiliary may be used to hold the pin in position, with the elastic or other auxiliary placed in the recess on the appendage and base, or around the locking mechanism of the pin to hold the pin within the securing member.

Alternatively, or in addition, an auxiliary channel may also run longitudinally between the pin and the base. A spring may be used to hold the pin in position. Both the elastic and the spring are positioned to apply some force on the pin to hold the appendage against the terminal aspect. Due to combined forces which may be applied to the pin, the pin will tend to actively move against the forces of their auxiliary, moving in a longitudinal direction with the auxiliary tending to drive the pin back into position. The pin, in effect may act in a piston motion.

The slot provided between the appendage of the pin and the bracket allows for rectangular, round and ribbon archwires to be used which allows for individual torque, angulation and rotational movements of every tooth. The degree of movement can be determined for each tooth separately and accurately according to a prescription, and can be either negative or positive depending upon the requirement of each individual tooth.

In yet a further aspect, the invention provides a method of orthodontic treatment using the orthodontic appliance of the invention including the steps of:

bonding the bracket to the enamel of an individual tooth;

fixing a pin with an appendage having an active surface within the channel formed between the securing member and the bracket of said orthodontic appliance, in such a manner that a slot is formed between the terminal aspect of the securing member, and the appendage of the pin such that the pin is able to retain longitudinal movement; and

placing an archwire so that it is secured in the slot formed between the terminal aspect of the securing member and the active surface of the appendage of the pin.

During treatment, an appliance according to the invention is affixed to a number of teeth of a particular patient. Each appliance may have the same or a different pin depending on the treatment required.

The following is a description of preferable features of the method, which may be varied depending upon the specific treatment requirements.

In the first stage of treatment, free tipping and rotation of a tooth is enhanced by a point to point contact between the terminal aspect of the securing member of the bracket and active surface of the pin. In this initial stage, the active surface of the pin may be sharp. The pin is firmly locked into position as it is located between the bracket and the securing member and no rotation of the pin may occur however, the pin may move longitudinally. This allows for rotation and angulation of the tooth.

It is envisaged that during the first stage of treatment, a round wire may be used, and a finishing wire may be used at the end of the treatment. Angulation and rotation of teeth can also be achieved by auxiliary wires which are utilised in such a way that a first order leverage is used in both instances. The angulation pins and the brackets allow for a transition of leverage to occur from second, third and then to first order leverage.

Such movement will be achieved by the utilisation of the first order of leverage whereby the fulcrum is the center of the bracket and the applied rotational or angulation force applied to the main archwire on both the mesial and distal of the bracket. The result is that less auxiliary components are required with a 50% force requirement on each side of the bracket. The result is a much less complex but more dynamic movement. The tooth can move in all three dimensions at the one time. Currently used auxiliaries may however be utilised with the appliance of the invention and may be modified in order to be used in the new appliance system.

The bracket may also incorporate small holes in the mid section of the securing member to allow ligation of severely displaced teeth. Once such displaced teeth are drawn to the main archwire, the formation of the channel may be achieved by the placement of the facia over the securing member, or placing the pin within the appliance.

Torquing can be achieved using ordinary torquing auxiliaries as used in the existing techniques if desired and therefore the finishing procedure may be achieved using current principles. It is preferred that treatment procedures be commenced in light round wires and finishing can be achieved in either round, rectangular or ribbon archwires.

The archwire height does not need to be changed during treatment as may be the case in existing combination brackets. The appliance of the invention is able to individually root torque all teeth including premolars in the finishing stage. Furthermore, the torque is controlled to the exact degree by the specific active surfaces of the pins that are utilised with the appliance.

The appliance of the, invention may be used both in an inverted or upright position during any stage of the aforementioned technique, so that the pin appendage may face in the gingival or occlusal direction. The appliance may be applied to teeth in any prescribed manner, including labialy, buccaly, lingually and palately.

The method also involves the use of brackets that include a pin where the appendage forms a tube adapted to secure the archwire in position. The pin is designed for use on the molars of a patient. A plurality of different tube pins may be used during the treatment of a patient to accommodate variations in the archwire used. For example, the tube pin may be replaced when the archwire is changed from a round wire to a rectangular or ribbon wire. It is envisaged that this method of providing molar tubes may be used in other techniques and conventional brackets. The tubes are easily interchanged during treatment to the desired configuration, simply by slipping a new tube pin into the molar bracket.

An advantage is that in most instances, only one or at most two molar tubes need to be used on each molar tooth. The occlusal plane does not vary as the archwire remains in the same position throughout the treatment. This differs from present utilisation of combination brackets where there is a need to change the position of the archwire during finishing in order to engage the horizontal bracket channel and combination tubes on molar teeth.

An advantage achieved by the bracket of the invention in general use, is that the archwire is held close to the enamel surface of the tooth. This is achieved by the formation of the slot between the recess in the pin and the bracket to hold the archwire. The archwire is held in the same position in relation to the tooth.

A further advantage is that the torque, and indeed angle, may be varied during treatment by changing the pin. In prior art appliances, torque is generally determined by the fixed bracket geometry. Therefore, it is either difficult, or not possible to vary the bracket torque during treatment.

A further advantage is that the teeth may be precisely moved in a prescribed manner individually and collectively. An operator may simply prescribe a particular pin in order to effect the correct treatment.

A further advantage is the smoothness of the bracket which adds to the comfort of the patient. As the archwire is held at a constant distance to the enamel surface on all the teeth, treatment procedures are enhanced and simplified.

The present invention will now be described with reference to the accompanying drawings. It should be understood that these drawings are merely illustrative of preferred embodiments of the invention, and the scope should not be considered to be limited thereto.

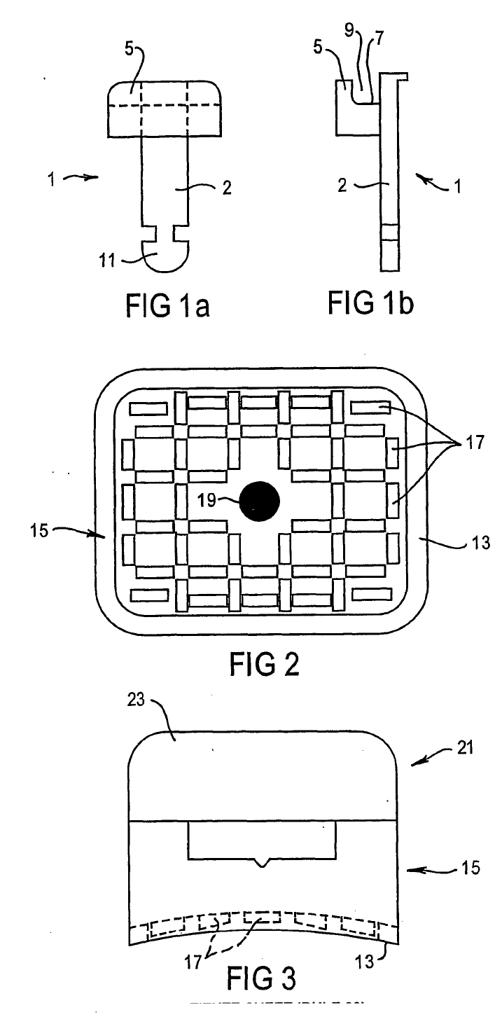

In FIG. 1(a), the pin (1) is shown having a stem (2) which is able to locate within the channel formed within an orthodontic appliance (not shown). The stem (2) is shaped specifically to locate firmly within the channel but may still have longitudinal movement. The pin has an appendage (5) with an active surface (3). The active surface acts in conjunction with the terminal aspect of a securing member (not shown) to form a slot through which an archwire may be passed. The stem of the pin has a locking means in a form of butterfly lock (11) at the head of the pin. In practice, the butterfly lock may be twisted to limit the longitudinal movement of the pin within the orthodontic appliance.

FIG. 1(b) is the side perspective of the pin of FIG. 1(a). In addition to the active surface, the appendage of the pin also has a contact surface (7) located within a recess (9). This contact surface can be utilised to attach other auxiliaries to said pin or to use bands to increase the force on the pin which may draw it back into contact with the terminal aspect of the securing member (not shown) when in use.

FIG. 2 illustrates the base surface of a preferred orthodontic appliance of the invention. The base surface has a raised perimeter surface (13) surrounding the outside of the base (15). Rectangular posts (17) are spaced in a regular pattern around the base. A pin gate (19) is positioned at the centre of the base. It has been found that the use of the rectangular posts, provides sufficient friction to surface areas to assist in holding the base firmly against the tooth surface.

FIG. 3 illustrates a side view of an orthodontic appliance (21), having a base (15) and a securing member (23). Raised posts (17) and a raised perimeter (13) are placed on the surface to adhere to the tooth.

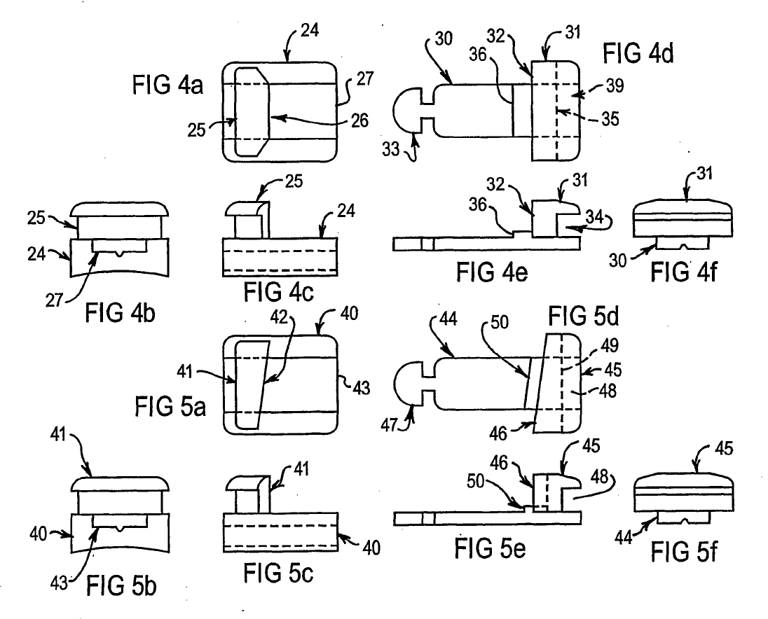

FIGS. 4(a), 4(b) and 4(c) illustrate a preferred embodiment of a bracket of the invention.

In FIG. 4(a) the bracket consists of a base (24) and a securing member (25). The terminal aspect of the securing member (26) is substantially flat to be complementary to a flat active surface of the appendage of a pin (not shown). The securing member (25) is located on said base (24) over a groove (27) in said base and defines a channel for receipt of the pins.

Front view (4b) shows the base (24) with the securing member (25) located thereon. There is a groove (27) located in the base and the securing member (25) overlays the groove to form a channel for receipt of the pin.

Side view (4c) shows the base (29) and the securing member (25).

FIG. 4(d) shows a pin for use with the bracket of FIGS. 4(a) to 4(c). The pin has a stem (30) and an appendage (31). The front surface of the appendage defines an active surface (32). The end of the pin opposite to the end at which the appendage is located has a locking means in the form of a butterfly clip (33). There is also a recess (34) in the appendage opposite the active surface (32) in which there is a further contact surface (35). Stem (30) also has a raised portion (36) in front of such appendage (31) to limit movement of said pins relative to the bracket (not shown) to ensure the dimensions of the slot do not go below a certain size. A further advantage of the raised portion (36) is that it can be modified to control the “in and out” of the wire relative to the tooth. That is, the thickness of the raised portion (36) determines the distance which the wire will be held from the tooth. This enables a more effective treatment.

FIG. 4(e) shows a side elevation of the same pin and demonstrate the active surface (32) of the appendage (31) as well as the raised surface of the pin immediately preceding the appendage (36) and the nature of the recess (34).

FIG. 4(f) shows the front view of the pin showing the appendage (31) and the stem (30).

FIGS. 5(a), 5(b) and 5(c) illustrate a preferred embodiment of a further bracket of the invention.

In FIG. 5(a) the bracket consists of a base (40) and a securing member (41). The terminal aspect of the securing member (42) is angled relative to the longitudinal axis of the pin (not shown). The securing member (41) is located on said base (40) over a groove (43) in said base and defines a channel for receipt of the pins.

Front view 5(b) shows the base (40) with the securing member (41) located thereon. There is a groove (43) located in the base and the securing member (41) overlays the groove to form a channel for receipt of the pin.

Side view 5(c) shows the base (40) and the securing member (41).

FIG. 5(d) shows a pin with a stem (44) and an appendage (45). The front surface of the appendage defines an active surface (46). The active surface is angled relative to the longitudinal axis of the pin. The end of the pin opposite to the end at which the appendage is located has a locking means in the form of a butterfly clip (47). There is also a recess (48) in which there is a further contact surface (49). Stem (44) also has a raised portion (50) in front of such appendage (45) to limit movement of said pins relative to the bracket to ensure the dimensions of the slat formed maintain a certain dimension.

FIG. 5(e) shows a side elevation of the same pin and demonstrates the active surface (46) of the appendage (45) as well as the raised surface of the pin immediately preceding the appendage (50) and the nature of the recess (48).

FIG. 5(f) shows a front elevation of a pin showing the stem (44) and the appendage (45).

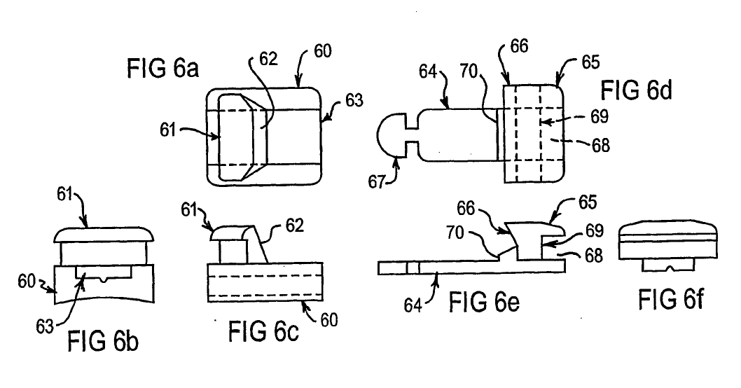

FIGS. 6(a), 6(b) and 6(c) illustrate a preferred embodiment of a bracket of the invention.

In FIG. 6(a) the bracket consists of a base (60) and a securing member (61). The terminal aspect of the securing member (62) is inclined at an angle relative to the plane defined by the base of the bracket. The securing member (61) is located on said base (60) over a groove (63) in said base and defines a channel for receipt of the pins.

Front view 6(b) shows the base (60) with the securing member (61) located thereon. There is a groove (63) located in the base and the securing member (61) overlays the groove to form a channel for receipt of the pin.

Side view (6c) shows the base (60) and the securing member (61). The inclined nature of the terminal aspect of the securing member is also illustrated.

FIG. 6(d) shows a pin (62) with a stem (64) and an appendage (65). The front surface of the appendage defines an active surface (66). The end of the pin opposite to the end at which the appendage is located has a locking means in the form of a butterfly clip (67). There is also a recess (68) in which there is a further contact surface (69). Stem (64) also has a raised portion (70) in front of such appendage (65) to limit movement of said pins relative to the bracket to ensure the dimensions of the slat formed maintain a certain dimension.

FIG. 6(e) shows a side elevation of the same pin that demonstrates the active surface (66) of the appendage (65) as well as the raised surface of the pin immediately preceding the appendage (70) and the nature of the recess (69).

It should be understood that the above description is merely illustrative of the present invention and any modification that do not depart from the spirit or ambit of the invention is also to be included herein.

1. An orthodontic appliance including:
a bracket, having:
a substantially flat base for engaging a tooth and,
a securing member having a terminal aspect; and
a pin having an appendage having an active surface;
wherein the base and the securing member form a channel adapted to receive the pin to secure the pin in a position to form a slot between the terminal aspect of the securing member and the active surface of the appendage of the pin;
said pin having longitudinal movement within the channel, wherein said movement enables the dimensions of the slot formed between the terminal aspect of the securing member and the active surface of the appendage of the pin to be variable.

2. An orthodontic appliance according to claim 1 wherein said terminal aspect of said securing member and said active surface of said appendage of said pin are configured in a complementary fashion to provide a prescribed force to a tooth of a patient.

3. An orthodontic appliance according to claim 2 wherein the prescribed force to the tooth of the patient is angulation and/or torque movement for the tooth.

4 An orthodontic appliance according to claim 1 wherein said terminal aspect of said securing member is inclined at an angle relative to the plane defined by the base of the bracket.

5. An orthodontic appliance according to claim 4 wherein the angle is defined to provide a pre-set angulation and/or torque movement for the tooth.

6. An orthodontic appliance according to claim 1 wherein said terminal aspect of said securing member is at an angle relative to a plane that is perpendicular to both the plane defined by the base and the longitudinal axis of the pin.

7. An orthodontic appliance according to claim 6 wherein said angle is defined to provided a pre-set angulation and/or torque movement for the tooth.

8. An orthodontic appliance according to claim 1 wherein the active surface of the appendage of the pin faces gingivally and the terminal aspect of the securing member faces occlusally; said pin further including a recess having at least one contact surface on the occlusal surface of the appendage, and an auxiliary channel running longitudinally between the pin and the flat base, for placement of one or more auxiliaries.

9. An appliance according to claim 8 wherein the auxiliary is either an elastic or a spring which affixes in the recess of the pin and through the auxiliary channel, and acts to force the pin in a gingival direction toward the terminal aspect.

10. An orthodontic appliance according to claim 1 wherein, in use, an archwire is secured within the slot formed between the terminal aspect of the securing member, and the appendage of the pin.

11. An orthodontic appliance according to claim 10, wherein the active surface of the appendage of the pin, in conjunction with the archwire, in use, apply a prescribed force to a tooth of a patient.

12. An orthodontic appliance according to claim 11, wherein the prescribed force applied to a tooth is torque or angulation.

13. An orthodontic appliance according to claim 11, wherein in use, the prescribed force applied to a tooth is varied by the longitudinal movement of the pin.

14. An orthodontic appliance according to claim 1, wherein the bracket includes a guide to assist in the placement of the pin.

15. An orthodontic appliance according to any one of the preceding claims wherein the appliance includes a plurality of pins having differing active surfaces, wherein in use, a pin may be removed and replaced with an alternative pin depending on the type of force to be applied to the tooth of a patient in use.

16. An orthodontic appliance including:
a bracket, having:
a substantially flat base for engaging a tooth and,
a securing member having a terminal aspect; and
a pin having an appendage having an active surface;
wherein the base and the securing member form a channel adapted to receive the pin to secure the pin in a position to form a slot between the terminal aspect of the securing member and the active surface of the appendage of the pin;
said pin having longitudinal movement within the channel, wherein said movement enables the dimensions of the slot formed between the terminal aspect of the securing member and the active surface of the appendage of the pin to be variable,
wherein said pin further includes a locking means.

17. An orthodontic appliance according to claim 16 wherein said locking means is a butterfly clip located at the end of the pin opposite to the end on which the appendage is located.

18. An orthodontic appliance according to claim 17 wherein said butterfly clip is flexible enabling said clip to be deformed, thereby locking the pin in the channel formed by the base and the securing member to limit the movement of the pin.

19. An orthodontic appliance according to claim 1 wherein the surface of the base that adheres to the tooth includes a plurality of raised surfaces thereon.

20. An orthodontic appliance according to claim 17 wherein the raised surfaces are rectangular posts and substantially fill the surface of the base.

21. An orthodontic appliance according to claim 18 wherein the rectangular posts have a length of from about 0.25 to about 0.35 mm and a width of between 0.1 to 0.2 mm.

22. An orthodontic appliance including:
a bracket, having:
a substantially flat base for engaging a tooth and,
a securing member having a V-shaped or truncated V-shaped terminal aspect;
and a pin having a stem and a foot type appendage, toward one end of the stem,
said pin having an active surface on the upper surface of the foot type appendage;
when the base and the securing member form a channel adapted to receive the pin to secure the pin in a position to form a slot between the terminal aspect and the active surface of the appendage of the pin;
said pin having longitudinal movement within the channel, wherein said movement enables the dimensions of the slot formed between the V-shaped or truncated V-shaped terminal aspect and the active surface of the appendage of the pin to be variable.

23. A pin adapted for use in an orthodontic appliance according to claim 1 or 22, said pin having a stem adapted to have longitudinal movement within the channel formed between the securing member and the base of the bracket, and
said pin including an appendage having at least one active surface, said active surface or surfaces being configured to provide, in use, and in conjunction with an archwire, a prescribed force upon a tooth of a patient,
whereas, the angle of the active surface relative to the archwire is altered following longitudinal movement of the pin within the appliance.

24. A pin according to claim 23, wherein the prescribed force is torque and/or angulation.

25. A method of orthodontic treatment using an orthodontic appliance according to claim 1 or 22 including the steps of:
bonding the bracket to the enamel of an individual tooth;
fixing the pin within the channel formed between the securing member and the base of the bracket of the orthodontic appliance, in such a manner that a slot is formed between the terminal aspect of the securing member and the active surface of the appendage of the pin; and
placing an archwire so that it is secured in the slot;
wherein the pin retains longitudinal movement within the channel, which movement varies the dimensions of the slot.

26. A method according to claim 25 wherein during treatment the bracket and/or the pin and/or the archwire may be replaced and varied depending upon the treatment required to that tooth.

27. A method according to anyone of claims 25 or 26, wherein the appliance is placed in either an inverted or an upright position so that the appendage of the pin faces in either the gingival or occlusal direction.

28. A method according to claim 27 wherein the appliance is placed so that the pin points in the gingival direction with the appendage of the pin facing the occlusal direction.

29. A method according to any one of claims 25 to 28, wherein the appliance is applied to the tooth in a labialy, buccaly, lingualy or palately manner.

30. A method according to any one of claims 25 to 29, wherein an auxiliary is affixed around the pin and the bracket, and the appendage of the pin, so as to apply a force on the appendage of the pin toward the terminal aspect.
